(19) United States
(12) Patent Application Publication
(10) Pub. No.: US 2023/0306533 A1
(43) Pub. Date: Sep. 28, 2023

(54) METHODS OF CONFIGURING A STATE MACHINE TO MANAGE A COMMUNITY SOLAR ENERGY GENERATING SYSTEM

(71) Applicant: Arcadia Power, Inc., Washington, DC (US)

(72) Inventors: Brendan Brown, San Diego, CA (US); Colin MacKenzie, Jersey City, NJ (US)

(21) Appl. No.: 17/701,825

(22) Filed: Mar. 23, 2022

(51) Int. Cl. G06Q 50/06; G06Q 30/00

(52) U.S. Cl. CPC G06Q 50/06; G06Q 30/018

(57) ABSTRACT

Implementations of the disclosed subject matter may provide a method to receive, at a server that includes a state machine, at least a first zip code and a first energy utility name of a first user to enroll in a community solar energy generating system. The server may generate a first compilation of data that includes the received first zip code, the received first energy utility, a determined first geographic location, and the one or more first regulatory requirements. The state machine may be changed to a first state based on the first compilation of data received via an Application Program Interface (API). The server may generate a first interface to be displayed to the first user based on the first state of the state machine. The server may receive responses to one or more first inputs received by the first interface.

### BACKGROUND

Presently, customers in certain utility territories are able to subscribe to the energy generated by renewable energy sources, such as wind power, solar power, and the like as a service separate from their traditional energy distribution company and/or supplier, such as a utility company. Different utility territories typically have different rules, regulations, and requirements for enrollment for a subscription to renewable energy generation. Such differences increase the difficulty in having a scalable enrollment system for the renewable energy generation that can be modified and/or maintained.

### BRIEF SUMMARY

According to an implementation of the disclosed subject matter, a method may be provided to receive, at a server that includes a state machine, at least a first zip code and a first energy utility name of a first user to enroll in a community solar energy generating system. The server may determine a first geographic location based on the received first zip code and one or more first regulatory requirements for the first geographic location. The server may generate a first compilation of data that includes the received first zip code, the received first energy utility, the determined first geographic location, and the one or more first regulatory requirements. The method may include providing, at the server, the first compilation of data via an application program interface (API) to the state machine. The state machine may be changed to a first state based on the first compilation of data received via the API. The server may generate a first interface to be displayed to the first user based on the first state of the state machine, where the first interface is configured to receive one or more first inputs from the first user. The method may include receiving, at the server, responses to the one or more first inputs received by the first interface.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example method of configuring a state machine to manage enrollment with a community solar energy generating system according to an implementation of the disclosed subject matter.

FIGS. 2-4 show optional additional operations of the example method of FIG. 1 according to implementations of the disclosed subject matter.

FIGS. 5-9 show example portions of the state machine according to an implementation of the disclosed subject matter.

FIGS. 10-12 show an example flow of operations in the state machine of FIGS. 5-9 according to an implementation of the disclosed subject matter.

FIG. 13 shows an example display for receiving information for enrollment with a community solar energy generating system that may be used by the state machine according to an implementation of the disclosed subject matter.

FIG. 14 shows a network arrangement of energy generating systems, servers, databases, and customer devices according to an implementation of the disclosed subject matter.

FIG. 15 shows an example database structure for a database according to an implementation of the disclosed subject matter.

FIG. 16 shows a customer's device that may interface with the network arrangement shown in FIG. 14 according to an implementation of the disclosed subject matter.

### DETAILED DESCRIPTION

Implementations of the disclosed subject matter provide a state machine at a server to manage enrollment of users in a community solar energy generating system. The state machine may include hardware and/or software that may be scalable and/or modifiable as new rules, regulations, requirements, utilities, and/or geographic areas are added. In some implementations, the server may generate a compilation of data that includes a received first zip code, a name of a first energy utility, a determined geographic location, and/or one or more regulatory requirements. The server may provide the compilation of data via an application program interface (API) to the state machine. The state of the state machine may be changed based on the compilation of data received via the API.

Regulatory and data requirements for enrolling customers with a community solar energy generating system may vary on a state-by-state, utility-by-utility, and/or project-by-project basis. For example, regulators in Massachusetts currently require customers to electronically scroll through project terms before enrollment may be completed. In another example, for a portion of New York being serviced by Consolidated Edison (ConEd™), users currently grant community solar managers access to their utility data by selecting an item in an email sent by ConEd™. As the number of community solar energy generating systems increase, the regulators, utilities, and project developers may create new rules for community solar enrollment systems to adhere to.

To enroll a user with a community solar energy generating system, data may be collected. Some of the data collection may depend on a market and/or geographic region that the user is in, and/or data requested may be optional in certain markets and/or geographical regions. Data collected from the user may include, for example, a zip code, a user's electric utility, third-party login information or account credentials, payment information (e.g., credit card information, checking account information, bank information, and the like), and/or consolidated billing information (for the user's utility and the community solar energy generating system). Implementations of the disclosed subject matter may manage regulations, utilities, projects, and/or other requirements for enrolling users with a community solar energy generating system with a state machine.

An enrollment system for a community solar energy generating system where distinct enrollment experiences may be provided for each variation has drawbacks, as adding new rules, requirements, regulations, features, and the like to such as system may be difficult. That is, adding such new rules, requirements, regulations, and/or features for one or more distinct enrollment experiences may create operational conflicts with existing rules, requirements, regulations, and/or features. The structure of software that may be a portion of the enrollment system may be difficult to modify when there are distinct enrollment experiences for each variation, as the code for such software may be difficult to read, and/or its structure may be difficult to understand. That is, the complexity of the software for the distinct enrollment experiences may make it difficult to maintain and/or change in order to meet the differing and/or evolving requirements of varying markets, jurisdictions and utility areas.

An enrollment system for a community solar energy generating system that uses branch logic to handle conditions in a single enrollment experience for each variation has similar drawbacks, as such a branch logic system would not provide scalability, as variation between each of the different enrollment experiences may increase as the number of rules, requirements, regulations, and/or features increase, and/or as the different geographic regions handled by the system increase.

Implementations of the disclosed subject matter provide a state machine for an enrollment system for a community solar energy generating system which may provide increased scalability as the number of rules, requirements, regulations, and/or features increase, and/or the number of areas and/or geographic locations where community solar energy generating systems are provided. The state machine reduces the complexity in modifying the enrollment of users with the community solar energy generating system, which may reduce the creation of operational conflicts with existing rules, requirements, regulations, and/or features as modifications are made. The state machine of the disclosed subject matter may reduce the complexity of the enrollment system for the community solar energy generating system, which may increase the ease in maintaining and/or modifying the enrollment system. That is, the reduced complexity of the state machine of the disclosed subject matter may reduce resources, including hardware and/or software computing resources the development and maintenance of the enrollment system, and/or may increase customer conversion and/or retention.

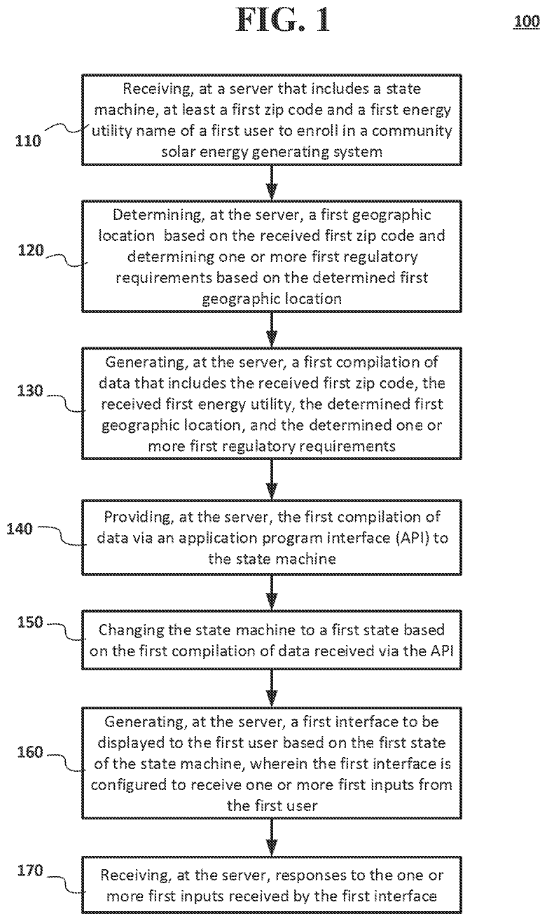

FIG. 1 shows an example method 100 of configuring a state machine to manage enrollment with a community solar energy generating system according to an implementation of the disclosed subject matter.

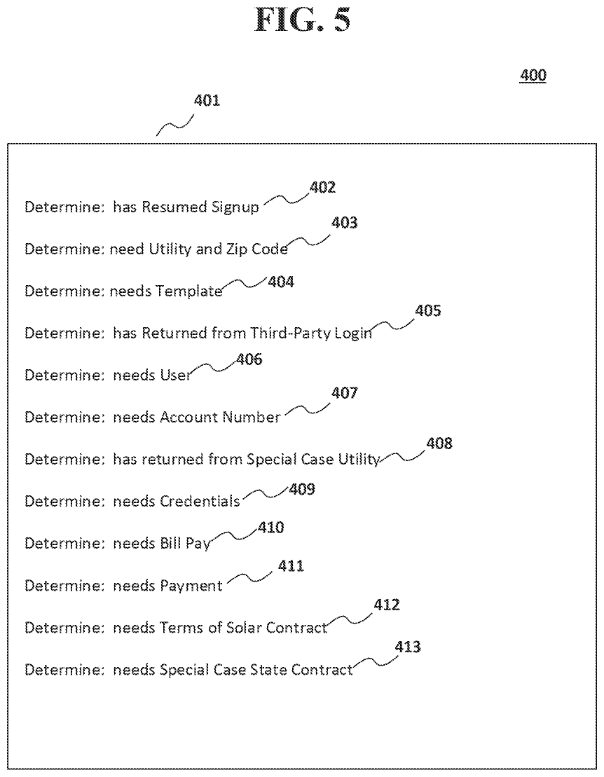

At operation 110, a server that includes a state machine may receive at least a first zip code and a first energy utility name of a first user to enroll in a community solar energy generating system. For example, the state machine may be state machine 400 shown in FIGS. 5-9 and FIG. 14 and as described below, and may be part of a server that provides the customer allocation portal 50, which may determine subscribers among possible candidates for the solar energy generating system 42. The state machine may include hardware and/or software.

At operation 120, the server may determine a first geographic location based on the received first zip code and may determine one or more first regulatory requirements for the first geographic location. That is, the server may determine the geographical location (e.g., town, city, state, geographic region, or the like) of the user based on the user's zip code. Using the determined geographical location of the user, the server may determine regulatory requirements for the geographical location. Regulatory requirements may include, for example, state-specific disclosure forms and/or information requirements, opt-out and/or rescission rights, regulatory requirements for application of bill credits are applied to a customer's utility bill, and the like. For example, a state (e.g., Massachusetts) may require a user to scroll through the one or more pages of solar contracts in order to accept them. In another example, a state (e.g., Illinois) may require users to sign one or more forms (e.g., an agreement applicable to the jurisdiction of the Illinois Power Agency (IPA)). Implementations of the disclosed subject matter may determine regulatory requirements based on the user's zip code and/or the user's energy utility.

At operation 130, the server may generate a first compilation of data that includes the received first zip code, the received first energy utility, the determined first geographic location, and the determined one or more first regulatory requirements.

At operation 140, the server may provide the first compilation of data via an application program interface (API) to the state machine. That is, the server may make the first compilation of data accessible to the state machine via the API. The state machine may retrieve one or more portions of the first compilation of data via the API.

At operation 150, the state machine may be changed to a first state based on at least a portion of the first compilation of data received via the API. A state of the state machine may be different based on the data received. That is, different compilations of data may respectively produce different state of the state machine.

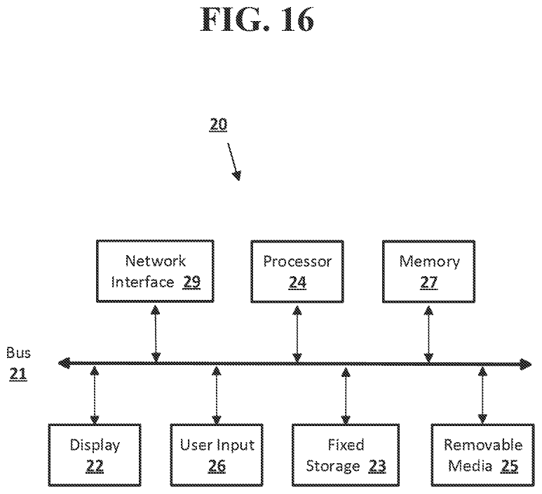

At operation 160, the server may generate a first interface to be displayed to the first user based on the first state of the state machine. The first interface may be configured to receive one or more first inputs from the first user. The first interface may be displayed on display 22 of device 20 shown in FIG. 16.

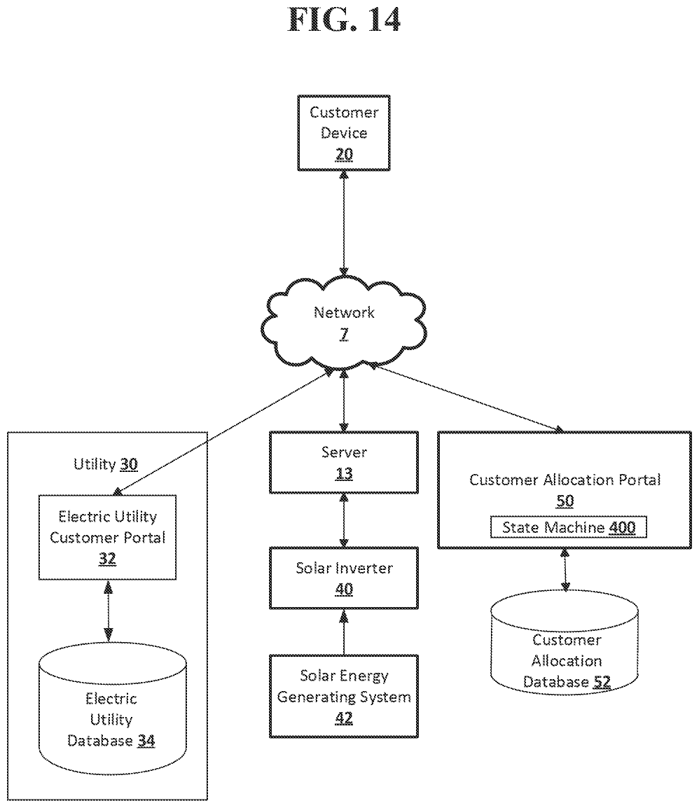

At operation 170, the server may receive responses to the one or more first inputs received by the first interface. For example, the first interface may be displayed on display 22 of device 20. Inputs received by the user input 26 of device 20 based on the displayed first interface may be transmitted from the device 20 to the server (e.g., the server for the customer allocation portal 50 shown in FIG. 14).

In some implementations, method 100 may include having the server enroll the first user with the community solar energy generating system based on the received responses (e.g., the server for the customer allocation portal 50 shown in FIG. 14).

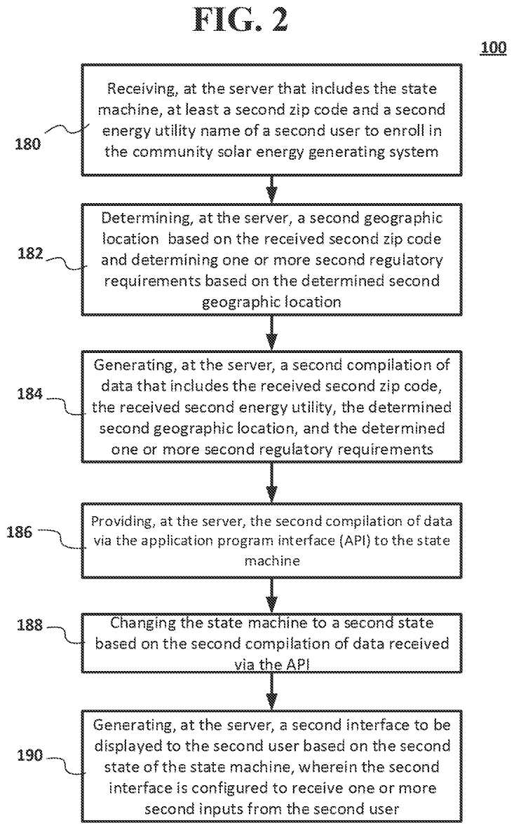

FIG. 2 shows optional operations of method 100 of FIG. 1 according to an implementation of the disclosed subject matter. The operations of FIG. 2 may be similar to those shown in FIG. 1, but the state machine may operate in a different state, as the compilation of data provided to the state machine may be different from that in the operations of FIG. 1.

At operation 180, the server (e.g., the server of the customer allocation portal 50 shown in FIG. 14) may receive at least a second zip code and a second energy utility name of a second user to enroll in the community solar energy generating system. The second zip code and/or the second energy utility name may be different from the first zip code and/or the first energy utility name.

At operation 182, the server may determine a second geographic location (e.g., town city, state, geographic area, or the like) based on the received second zip code, and may determine one or more second regulatory requirements based on the determined second geographic location.

At operation 184, the server may generate a second compilation of data that includes the received second zip code, the received second energy utility, the determined second geographic location, and the determined one or more second regulatory requirements. The second compilation of data may be different from the first compilation of data described above in connection with FIG. 1, as one or more of the second zip code, the second energy utility, the second geographic location, and the second regulatory requirements may be different from one or more of the first zip code, the first energy utility, the first geographic location, and/or the first regulatory requirements.

At operation 186, the server may provide the second compilation of data via the API to the state machine, and the state machine may change to a second state based on the second compilation of data received via the API at operation 188. As the second compilation of data may be different from the first compilation of data received by the state machine via the API, the second state of the state machine may be different than the first state of the state machine.

At operation 190, the server may generate a second interface to be displayed to the second user based on the second state of the state machine, where the second interface is configured to receive one or more second inputs from the second user. The second interface may be different from the first interface, as one or more of the second zip code, the second energy utility, the second geographic location, and the second regulatory requirements may be different from one or more of the first zip code, the first energy utility, the first geographic location, and/or the first regulatory requirements. Similarly, the one or more second inputs to be received by the second interface may be different from the one or more first inputs to be received by the first interface.

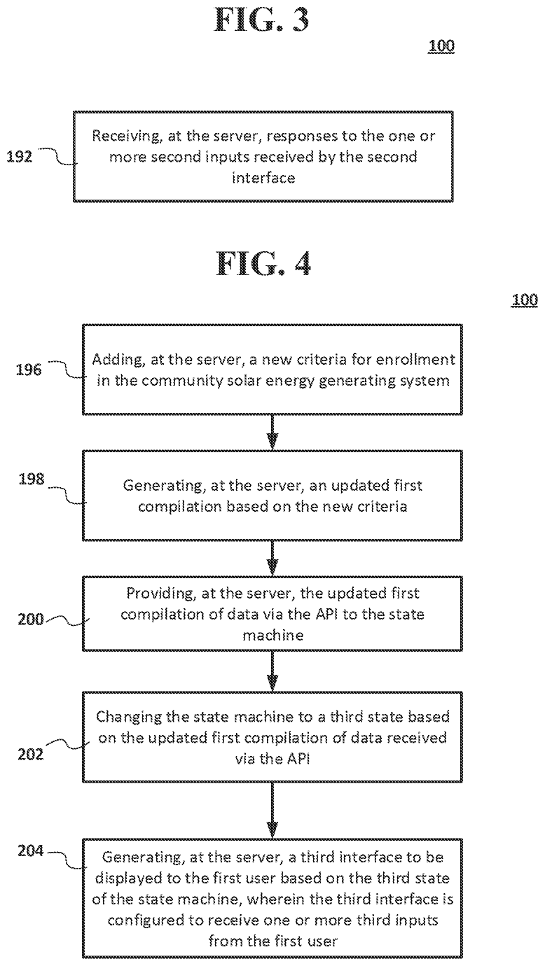

Optional operations of method 100 shown in FIG. 2 may include one or more of the operations shown in FIG. 3 according to an implementation of the disclosed subject matter. At operation 192, the server may receive responses to the one or more second inputs received by the second interface. In some implementations, the server may enroll the second user with the community solar energy generating system based on the received responses. For example, the server of the customer allocation portal 50 may permit the second user to have a subscription with the solar energy generating system 42 of FIG. 14 and may store the second user's information in the customer allocation database 52. The second user's information may include the second user's name, address, zip code, account information for the solar energy generation system, account information for the utility 30, billing information, and the like.

FIG. 4 shows optional operations of method 100 of FIG. 1 according to an implementation of the disclosed subject matter. At operation 196, the server may add a new criteria for enrollment in the community solar energy generating system. For example, the new criteria may include an incentive, account information, billing information, document requirements, and/or at least one information item for the first user, or the like.

At operation 198, the server may generate an updated first compilation based on the new criteria. At operation 200, the server may provide the updated first compilation of data via the API to the state machine. For example, the server of the customer allocation portal 50 may provide the updated first compilation of data to the state machine 400 shown in FIG. 14.

At operation 202, the state machine may change to a third state based on the updated first compilation of data received via the API. As the updated compilation of data may be different from the first compilation of data and/or the second compilation of data received by the state machine via the API, the third state of the state machine may be different than the first and/or second state of the state machine.

At operation 204, the server may generate a third interface to be displayed to the first user based on the third state of the state machine, where the third interface is configured to receive one or more third inputs from the first user.

FIGS. 5-9 show example portions of the state machine 400 according to an implementation of the disclosed subject matter. The state machine 400 may be hardware and/or software that may be part of a server that provides the customer allocation portal 50 shown in FIG. 14. The customer allocation portal 50 may handle enrollments for the community solar energy generating system 42. The operations performed by the portions of the state machine shown in FIGS. 5-9 may change the state of the state machine, which may change the information requested of the user and/or fetched for the enrollment with the community solar energy generating system. The server of the customer allocation portal 50 may receive input from the user from device 20 as part of the enrollment by the user with the community solar energy generating system. For example, the user may enter information for submission in one or more display screens displayed on the device 20.

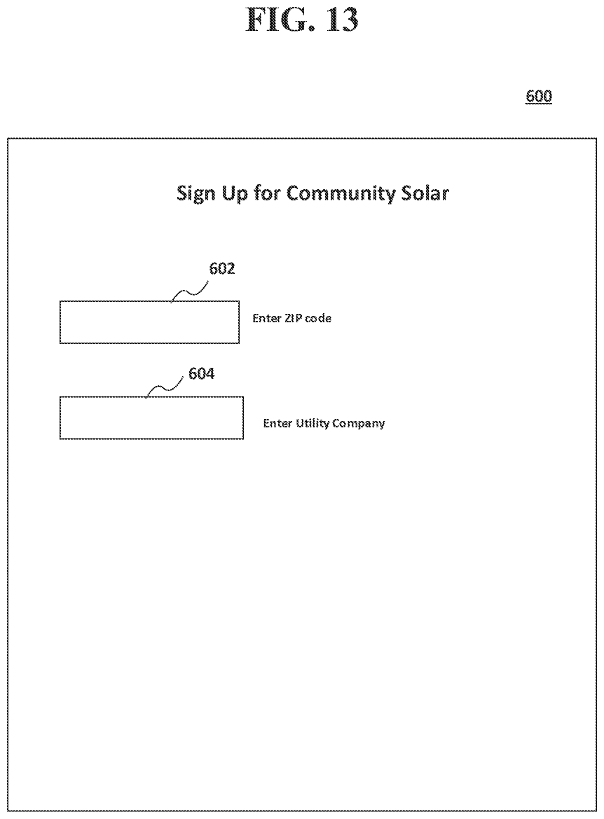

Portion 401 of the state machine 400 shown in FIG. 5 may perform one or more state determinations to manage the enrollment with a community solar energy generating system. At operation 402, the portion 401 of the state machine 400 may determine whether a user has resumed a signup process for enrollment with a community solar energy generating system. That is, operation 402 may determine whether the user previously started, but did not complete, the enrollment process for the community solar energy generating system. For example, operation 402 may determine whether the user has previously attempted enrollment via the customer allocation portal 50 for enrollment with the solar energy generating system 42 shown in FIG. 14. At operation 403, the portion 401 of the state machine 400 may determine whether the utility name and zip code of the user have been received. For example, display 600 shown in FIG. 13 may be displayed on display 22 of device 20 shown in FIG. 16. The user input 26 of device 20 may receive input for the zip code 602 and/or the utility company 604 for the user. The zip code 602 and/or the utility company 604 may be electronically scraped after entry and transmitted to the customer allocation portal 50. Operation 403 may determine whether inputs for the zip code 602 and utility company 604 have been received by state machine 400 via the customer allocation portal 50 from the device 20.

At operation 404, the portion 401 of the state machine 400 may determine a template (which may also be referred to as a funnel template) for an order of operations performed by the state machine based on the input received from the user, such as the ZIP code of the user's residence and the name of the utility company that provides electrical power to the user's residence. That is, a template may be selected from a variety of templates (i.e., a plurality of different templates) to collect information from a user for enrollment with the applicable community solar energy generating system and/or within the applicable territory of the user. The selection of the template may be based on, for example, the utility and the zip code entered by the user. For example, depending on the zip code and utility name entered by the user, the template selected may be different. Additional information may be collected from the user based on the selected template, where the received information may change the state of the state machine 400. For example, the information collected by the user may be different, based on the template that is selected.

At operation 405, the portion 401 of the state machine 400 may determine whether the user is enrolling with a community solar energy generating system using a third-party login. That is, a user may use a third-party website login (e.g., Google™, Facebook™, Apple ID′, and the like) as a login for the customer allocation portal 50 for enrollment with the community solar energy generating system. The third-party login by the user may provide identifying information about the user to the state machine 400 and/or the customer allocation portal 50.

At operation 406, the portion 401 of the state machine 400 may determine whether the user's name is still needed to enroll with a community solar energy generating system from a third-party login. For example, the state machine 400 may determine the name of the user from the credentials, account information with the utility, and/or other input received from the user.

At operation 407, the portion 401 of the state machine 400 may determine whether the account number for the user's account with a utility company (e.g., utility 30 shown in FIG. 14) has been provided and/or is accessible by the state machine 400. For example, some users may have enrolled and/or started enrollment with the community solar energy generating system using an account number of the utility (e.g., utility 30 shown in FIG. 14). That is, the account number may be received by the enrollment system for the community solar energy generating system (e.g., customer allocation portal 50 shown in FIG. 14), rather than credentials for the user's utility account which may be used to access the electric utility customer portal 32 shown in FIG. 14 to retrieve the user's account information.

At operation 408, the portion 401 of the state machine 400 may determine whether the user has been directed from a particular utility company to enroll with the community solar energy generating system. For example, the user may perform a login operation to the website of a special case utility, and then may be redirected to the customer allocation portal 50 to enroll with the community solar energy generating system using the login information of the special case utility. The enrollment process and the template used for the enrollment with the community solar energy generating system may be different when it is determined that the user has a special case utility. For example, the state machine 400 may perform different operations for enrollment for users who have Ameren™ as a utility company, in comparison to those who may have National Grid™ as a utility company.

At operation 409, the portion 401 of the state machine 400 may determine whether credentials (e.g., username, password, or the like) are available and/or needed so that the state machine 400 and/or the customer allocation portal 50 may electronically access the user's account with the utility to obtain account information and/or billing information that may be used for enrollment with the community solar energy generating system. For example, the state machine may determine whether it has the user's credentials to access the electric utility customer portal 32 for utility 30 shown in FIG. 14.

At operation 410, the portion 401 of the state machine 400 may determine whether the user has elected to enroll in a bill pay service, where the server of the customer allocation portal 50 may pay a utility bill from the utility 30 shown in FIG. 14 on behalf of a user when the user is also subscribed to the community solar energy generating system. The customer allocation portal 50 may separately bill the user based on the utility bill, the subscription to the community solar energy generating system, any credit received based on the enrollment with the community solar energy generating system, and/or any other services and/or products (such as bundled services and/or products) elected by user during one or more sign-up operations.

At operation 411, the portion 401 of the state machine 400 may determine whether a payment has been provided to the utility when the user has elected to enroll in bill pay (e.g., which may be determined at operation 410).

At operation 412, the portion 401 of the state machine 400 may determine whether the user has entered into a contract for a subscription to the community solar energy generating system. The state of the state machine 400 may be different based on, for example, the terms of the contract, a jurisdiction's regulatory requirements, one or more terms required by and/or for the applicable energy utility, any specific terms required by the community solar energy generating system, or the like.

At operation 413, the portion 401 of the state machine 400 may determine whether the user has entered into a special case state contract. For example, this may determine whether the user has executed an agreement applicable to the jurisdiction of the Illinois Power Agency (IPA), which may be needed for the enrollment process for the community solar energy generating system when the user has an Illinois-based utility and/or may be using an Illinois-based community solar energy generating system once enrolled.

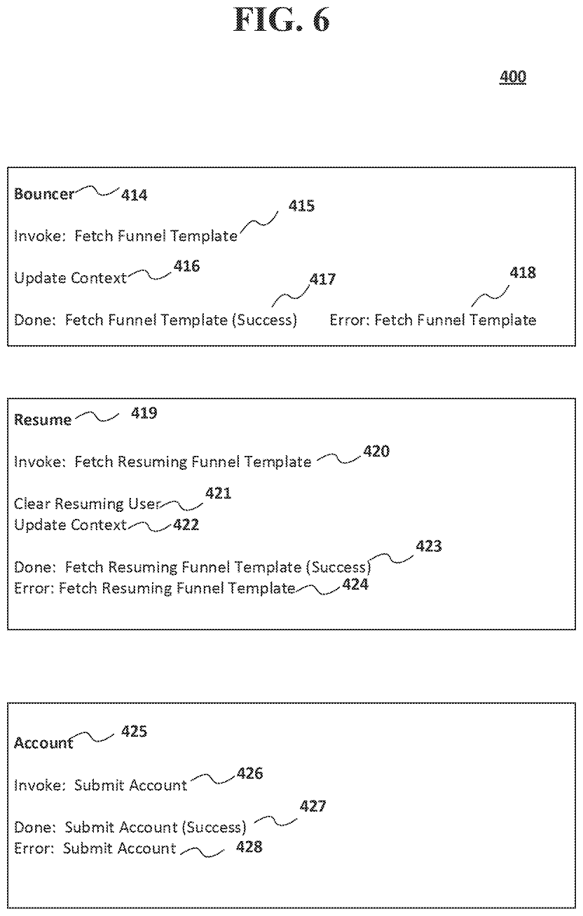

In some implementations, the operations 402-413 of portion 401 may always be determined before performing other operations of the other portions (e.g., portions 414, 419, 425, 429, 433, 437, 441, 445, 450, 454, 458, and/or 462 shown in FIGS. 6-9).

Portion 414 of the state machine 400 shown in FIG. 6 may perform operation 415 to fetch a funnel template based on one or more of the operations 402-413 performed by portion 401 which may change the state of the state machine 400. For example, portion 414 may be performed based on operation 404 of portion 401 shown in FIG. 5, which may determine whether a template is needed. The funnel template may be used by the state machine 400 for enrollment of the user with the community solar energy generating system. That is, the funnel template may provide an order of enrollment steps or operations, based on the on one or more of the operations 402-413 performed by portion 401 which may change the state of the state machine 400. In some implementations, portion 414 may redirect the user to a different funnel template when one or more states of the state machine 400 have changed, based on one or more inputs received.

At operation 416, the state machine 400 may update its context (i.e., state) based on the retrieval of the funnel template. At operation 417, the state machine 400 may successfully complete the retrieval of the funnel template. If the state machine 400 is unable to successfully retrieve the funnel template, operation 418 may indicate that there is an error in retrieving the funnel template.

Portion 419 of the state machine 400 shown in FIG. 6 may perform operation 420, which may fetch a resuming funnel template, which may be used by the state machine 400 when a part or portion of the enrollment of the user with the community solar energy generating system has been completed, but additional parts and/or portions of the enrollment remain. The funnel template may be selected based on the previous information provided by the user during the user's earlier enrollment process. As discussed above, the funnel template may be used to determine what information may be retrieved and/or requested from the user for the enrollment of the user with the community solar energy generating system. The resuming user may be cleared at operation 421, which may indicate that the user is no longer a resuming user when the enrollment process is completed. The context of the state may be updated at operation 422. That is, the state of the state machine 400 may be updated to indicate that the enrollment process is being resumed. Operation 423 may indicate that the resuming funnel has been successfully retrieved. Otherwise, operation 424 may indicate that there may be an error in retrieving the resuming funnel template. For example, an error message may be displayed, and/or the user may be prompted to re-enter information on a display screen generated by the customer allocation portal 50 so that a funnel template may be selected. Portion 419 of the state machine 400 may be used in connection with operation 402 of FIG. 5 and described above, where the state machine may determine whether the user has resumed signup.

Portion 425 of the state machine 400 may perform operation 426, which may submit the account information to the customer allocation portal 50 shown in FIG. 14 that has been retrieved and/or received by the user. For example, the submission may be a selection and/or authorization (e.g., selection of a user interface button, or the like) by the user to have the customer allocation portal 50 accept the provided information. In some implementations, the state machine 400 may submit account information retrieved from the electric utility customer portal 32 of utility 30 and may provide it to the customer allocation portal 50 as shown in FIG. 14. Operation 427 may indicate that the account information has been successfully submitted. Otherwise, operation 428 may indicate an error with the submission of the account information. For example, an error message may be displayed, and/or the user may be prompted to re-enter account information on a display screen generated by the customer allocation portal 50. Portion 425 of the state machine may be used in connection with operation 407 shown in FIG. 5 and described above, where the account number may be determined.

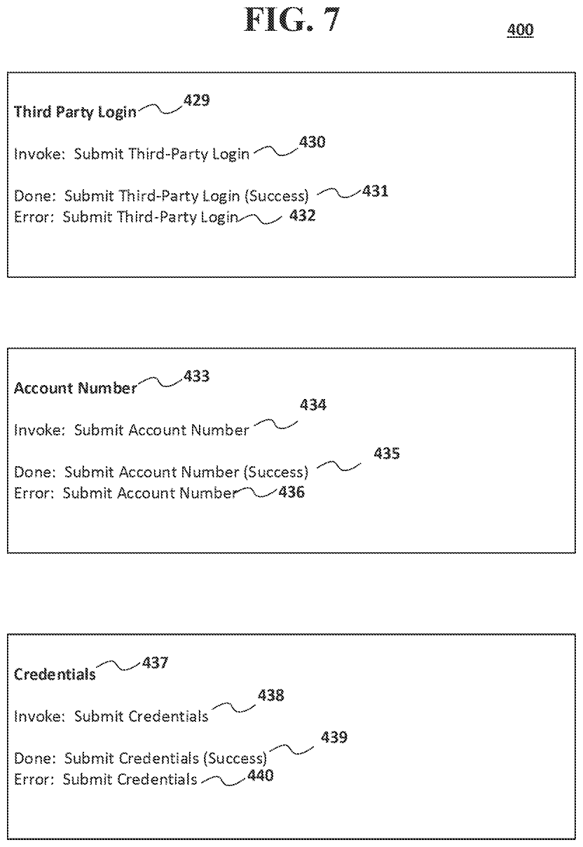

As shown in FIG. 7, portion 429 of the state machine 400 may perform operation 430, which may use a third-party website login (e.g., Google™, Facebook™, Apple ID™, and the like). For example, in some implementations, the third-party login may be provided to the customer allocation portal 50, and/or may use the third-party login to access the electric utility customer portal 32 shown in FIG. 14. Operation 431 may indicate the success of submitting the third-party login. Otherwise, operation 432 may indicate an error with the submission of the third-party login. For example, an error message may be displayed, and/or the user may be prompted to re-enter the third-party login information on a display screen generated by the customer allocation portal 50. Portion 429 may be used in connection with operation 405 of portion 401 shown in FIG. 5 and described above, where it is determined whether the user has returned from a third-party login.

Portion 433 of the state machine 400 may perform operation 434, which may submit the account number of the user's utility (e.g., utility 30 shown in FIG. 14) for the enrollment of the user with the community solar energy generating system. At operation 435, the submission of the account number may be successfully completed. Otherwise, operation 440 may indicate an error of the submission of the account number. For example, an error message may be displayed, and/or the user may be prompted to re-enter account information on a display screen generated by the customer allocation portal 50. Portion 433 may be used in connection with operation 407 of portion 401 shown in FIG. 5, where it is determined whether the account number is needed.

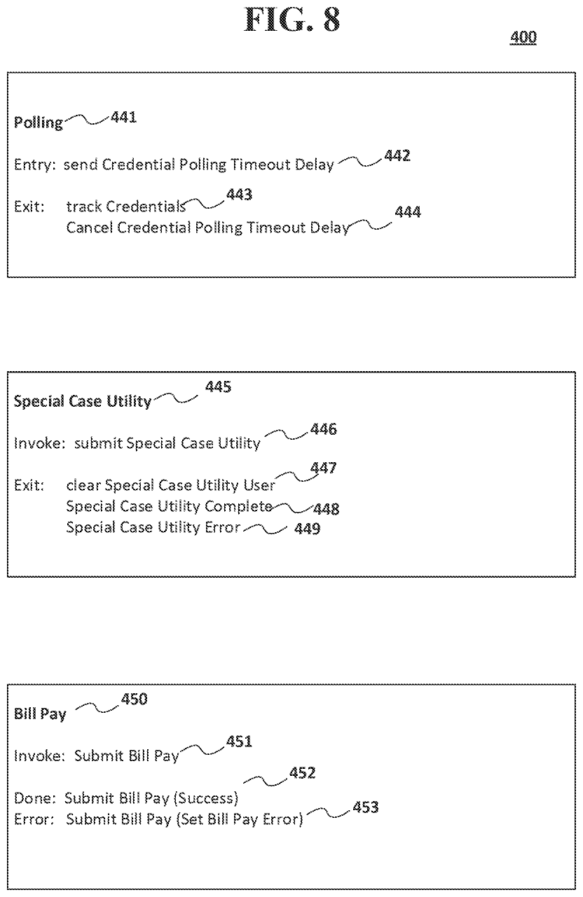

Portion 437 of the state machine 400 may perform operation 438, which may submit credentials to be used to retrieve user account information with the user's utility as part of the enrollment of the user with the community solar energy generating system. For example, the user may submit the credentials in an input section of a display screen that may be displayed by customer allocation portal 50. The submitted credentials may be used to retrieve the user's account information from the electric utility customer portal 32 of utility 30, shown in FIG. 14. At operation 439, the credentials may be successfully submitted. Otherwise, operation 440 may indicate an error of the submission of the credentials. For example, an error message may be displayed, and/or the user may be prompted to re-enter credential information on a display screen generated by the customer allocation portal 50. In some implementations, the portion 437 may use portion 441 shown in FIG. 8 to determine whether scrapers have retrieved the credentials, or whether additional time is needed to for the user to enter or re-enter credentials that may be scraped and provided to portion 437. Portion 437 may be used in connection with operation 409 of portion 401 shown in FIG. 5, which may determine whether the user's credentials are needed.

As shown in FIG. 8, portion 441 of the state machine 400 may perform operation 442 to send a credential polling timeout delay. This may delay a timeout operation to allow the state machine to attempt to retrieve the user's credentials for the utility. For example, a scraper may retrieve the user's entered credentials to access a utility account (e.g., electric utility customer portal 32 of utility 30 shown in FIG. 14). The delayed timeout operation may provide additional time for the scrapers to retrieve the credentials. At operation 443, the credentials may be retrieved, and the credential polling timeout delay may be canceled at operation 444.

Portion 445 of the state machine 400 may perform operation 446, which modify the state of the state machine based on a special case utility. That is, the enrollment of the user with the community solar energy generating system may be different for particular utilities (i.e., special case utilities). For example, the user's utility may be determined to be a special case utility based on the information provided for utility company 604 at display 600 of FIG. 14. Operation 447 may determine that the user is associated with a special case utility, and the submission of the special case utility may be completed at operation 448. Otherwise, operation 449 may indicate an error with a submission of the special case utility. For example, an error message may be displayed, and/or the user may be prompted to re-enter the name of the utility on a display screen generated by the customer allocation portal 50. Portion 445 may be used in connection with operation 408 of portion 401 shown in FIG. 5, where it is determined whether the user has a special case utility.

Portion 450 of the state machine 400 may perform operation 451, which may submit a bill pay feature, which may allow the customer allocation portal 50 to pay a user's utility bill for utility 30 when the user has enrolled with the community solar energy generating system. At operation 452, the submission of bill pay to change the state of the state machine may be successfully completed. Otherwise, operation 453 may indicate an error with the submission of the bill pay. For example, an error message may be displayed, and/or the user may be prompted to re-enter bill pay information, or may select an option to resubmit the bill pay information on a display screen generated by the customer allocation portal 50. Portion 450 may be used in connection with operation 410 of portion 401 shown in FIG. 5, which may determine whether the user is enrolled in bill pay services.

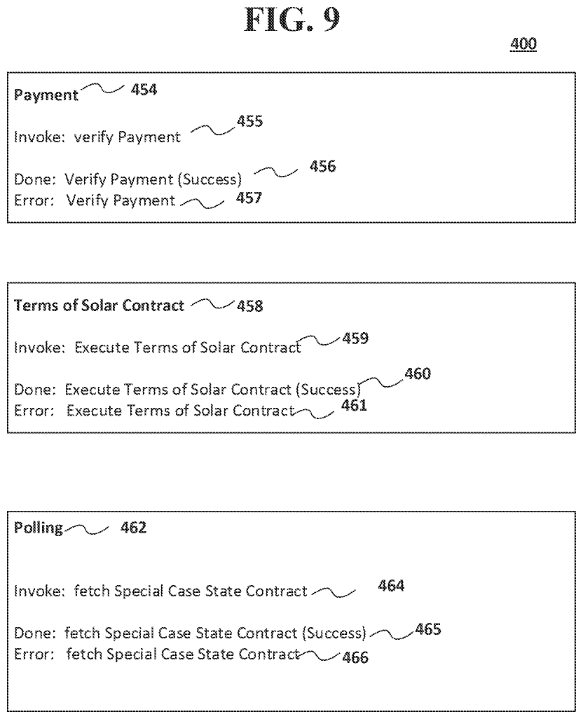

As shown in FIG. 9, portion 454 of the state machine 400 may perform operation 455, which may verify payment of a utility bill for a user's account with a utility. For example, if the user selects the bill pay feature described above, the customer allocation portal 50 may pay a user's utility bill for utility 30 when the user has enrolled with the community solar energy generating system. At operation 456, the payment may be verified and stored (e.g., in the customer allocation database 52 shown in FIG. 14 and/or other storage device). Otherwise, operation 457 may indicate that there is an error in verifying the payment. For example, an error message may be displayed, and/or the user may be prompted to select an option to re-submit the payment on a display screen generated by the customer allocation portal 50. Portion 454 may be used in connection with operation 411 of portion 401 shown in FIG. 5 and described above, which may determine whether a payment is needed.

Portion 458 of the state machine 400 may receive the executed terms of the solar contract at operation 459. That is, the terms of the contract for the user that has enrolled with the community solar energy generating system may be provided to the state machine 400 and may change the state of the state machine. At operation 460, the contract may be successfully executed. Otherwise, operation 461 may indicate an error of the execution of the contract. For example, an error message may be displayed, and/or the user may be prompted to select an option to re-execute the contract to the customer allocation portal 50. Portion 458 may be used in connection with operation 412 of portion 401 shown in FIG. 5 and described above, which may determine whether the terms of the solar contract are needed.

Portion 462 of the state machine 400 may perform operation 464 to fetch the special case state contract. For example, the special case state contract may be an agreement applicable to the jurisdiction of the Illinois Power Agency (IPA), which may be needed for the enrollment process for the community solar energy generating system when the user has an Illinois-based utility and/or may be using an Illinois-based community solar energy generating system once enrolled. At operation 465, the fetching of the special case state contract may be successful. Otherwise, operation 466 may indicate an error with fetching the special case state contract. For example, an error message may be displayed, and/or the user may be prompted to re-submit the special case state contract and/or select an option to re-submit the contract to the customer allocation portal 50. Portion 462 may be used in connection with operation 413 of portion 401 shown in FIG. 5, where it may be determined whether a special case state contract is needed.

In some implementations, the state machine may send a special case state polling interval delay to allow for time to fetch the special case state contract. When the special state contract has been successfully fetched, the special cse state polling interval delay may be ended.

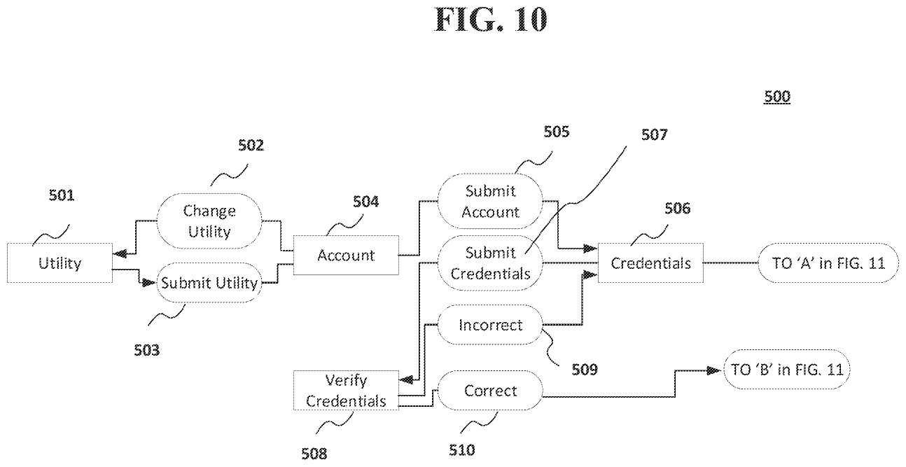

FIGS. 10-12 show an example flow 500 of operations in the state machine 400 of FIGS. 5-9 according to an implementation of the disclosed subject matter. Utility 501 may determine the utility based on operation 403 of portion 401 of the state machine 400. The utility may be changed at operation 502 based on, for example, the entry of the utility company 604 of display 600 of FIG. 13. The determined and/or changed utility may be submitted at operation 503.

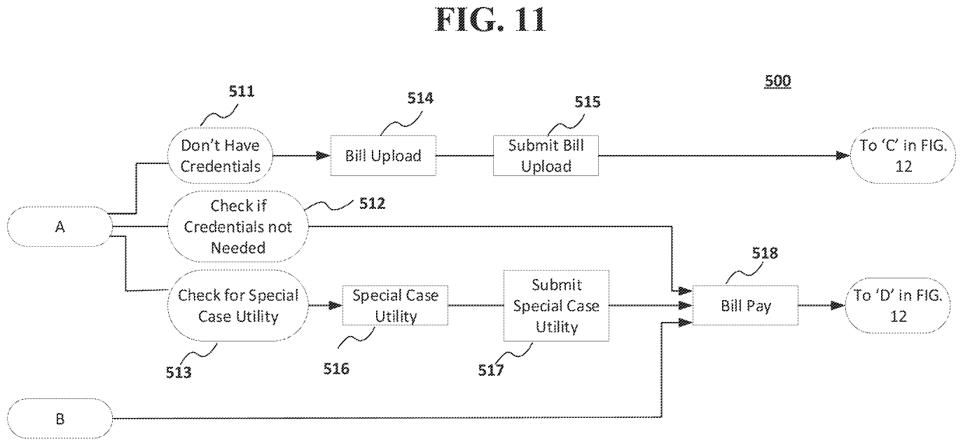

Account 504 may be the user's account of the utility 30 of FIG. 14, which may be determined at operation 407 of portion 401 of the state machine 400 shown in FIG. 5 and/or by portion 425 of the state machine shown in FIG. 6. The determined account may be submitted at operation 505. The credentials 510 of the account may be retrieved at operation 409 by portion 401 of the state machine 400 shown in FIG. 5 and/or in portion 437 shown in FIG. 6 and described above. The credentials 510 may be submitted at operation 507, and the credentials of the account may be verified at operation 508. For example, the verification may include portion 441 of the state machine 400 shown in FIG. 8 and described above, where a polling operation may determine whether scrapers have successfully authenticated the user's utility account credentials. In another example, the credentials may be verified by using the credentials to access the electric utility customer portal 32 shown in FIG. 14. If the credentials are incorrect at operation 509, the operations continue at “A” in FIG. 11. When the credentials are verified to be correct at operation 510, the operations may continue at “B” in FIG. 11.

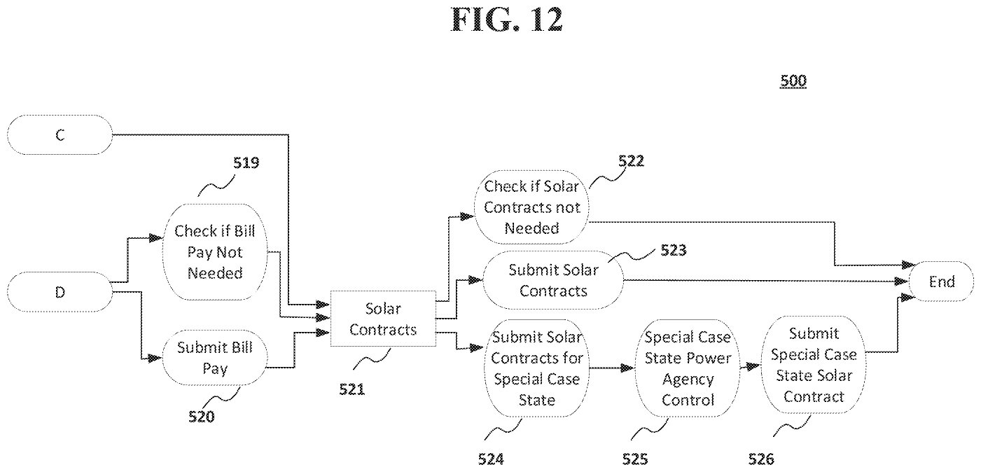

As shown in FIG. 11, at part “A” where the credentials are incorrect as determined in FIG. 10, state machine 400 may determine it does not have the credentials for the user account at operation 511. For example, the user may not have an online account for their utility, and instead may submit a copy of a bill from the user's utility. The copy may be an image and/or document file (e.g., a portable document format (PDF) file). The copy of the bill may be stored at a storage device (e.g., customer allocation database 52 shown in FIG. 14). In some implementations, the copy of the bill may be reviewed and/or verified. That is, the state machine may receive utility billing information from the user (e.g., via the customer allocation portal 50) by the user uploading a copy of one or more recent bills for the utility at operation 514, which may be submitted at operation 515. This may provide the state machine 400 with the utility bill information that the state machine would have otherwise retrieved by using the credentials to access the user's utility account. When the copy of the bill from the user's utility has been submitted, the operation may proceed to “C” in FIG. 12.

At operation 512, the state machine may determine that the credentials of the user account are not needed. When the credentials are not needed, the state machine may determine whether the user has bill pay at operation 518, which may be determined for example, at operation 410 of the portion 401 of the state machine 400 as shown in FIG. 5, and then may proceed to “D” in FIG. 12.

At operation 513, the state machine 400 may determine whether the user's utility is a special case utility. For example, this may be determined by operation 408 of portion 401 of the state machine as shown in FIG. 5 and/or by portion 445 of the state machine 400 shown in FIG. 8 and described above. The determined special case utility 516 may be submitted at operation 517.

When the special case utility has been submitted, the state machine 400 may determine whether the user has bill pay at operation 518, which may be determined for example, at operation 410 of the portion 401 of the state machine 400 as shown in FIG. 5 and/or by portion 450 of state machine 400 shown in FIG. 8, and then may proceed to “D” in FIG. 12.

When the credentials are verified to be correct at operation 510 in FIG. 10, the operations may continue at “B” in FIG. 11, where the state machine 400 may determine whether the user has bill pay at operation 518, and then may proceed to “D” in FIG. 12.

At “C” of FIG. 12 and after the copy of the bill from the user's utility has been submitted, the state machine 400 may determine whether there is a solar contract at operation 521. For example, operation 412 of portion 401 of the state machine may determine whether there is a solar contract that has been executed by the user, and/or may use portion 445 of the state machine 400 shown in FIG. 8 and described above.

At “D” of FIG. 12, and operation 519 may determine whether bill pay is not needed. For example, operation 519 may be performed when it is determined at operation 518 of FIG. 11 that the user does not have bill pay. If bill pay is not needed, the state machine 400 may determine whether there is a solar contract at operation 521 as described above.

At “D” of FIG. 12, when it is determined that the user has bill pay, the bill pay may be submitted at operation 520, and the state machine 400 may determine whether there is a solar contract at operation 521 as described above.

At operation 522, the state machine 400 may determine whether the solar contract is not needed. When it is determined that the solar contract is not needed, the method 500 may be completed, and the state of state machine 400 may be determined based on the operations of method 500.

At operation 523, the executed solar contract may be submitted. The method 500 may be completed, and the state of the state machine 400 may have a state based on the operations of method 500.

At operation 524, the solar contracts may be submitted for a special case state at operation 524. For example, different states of the United States may have different requirements for contracts with a community solar energy generating system (e.g., Illinois may have different requirements for contracts than other states). The state agency for power contracts may review the solar contract at operation 525 to determine whether the contract complies with state guidelines. When the contract complies with the terms as specified by the state agency for power control, the special case state solar contract may be submitted, and the state of the state machine 400 may have a state based on the operations of method 500.

The following examples using method 500 shown in FIGS. 10-12 may demonstrate that different utilities may change the state of the state machine 400, and/or may have different flows within method 500. In a first example, a first utility (e.g., National Grid™) may be determined at operation 501, and submitted at operation 503 of FIG. 10. The account may be determined at operation 504, and the account may be submitted at operation 505. The credentials of the account may be submitted at operation 507, the credentials may be verified at operation 508, and the credentials may be determined to be correct at operation 510. Operation 518 may determine whether the user has bill pay, and the bill pay may be submitted at operation 520. The solar contracts may be determined at operation 521, and may be submitted at operation 523. Each of these operations may change the state of the state machine 400, and/or may change the information requested from the user.

In another example, a second utility (e.g., Ameren™) may be determined at operation 501, and submitted at operation 503 of FIG. 10. The account may be determined at operation 504, and the account may be submitted at operation 505. The credentials of the account may be submitted at operation 507, and operation 513 may determine that the second utility is a special case utility. Operation 517 may submit the special case utility. Operation 518 may determine whether the user has bill pay, and the bill pay may be submitted at operation 520. The solar contracts may be determined at operation 521, and the solar contracts for special case state may be performed at operation 524. A special case state power agency (e.g., Illinois) may control the contracts at operation 535, and the special case state solar contracts may be submitted at operation 526. Again, each of these operations may change the state of the state machine 400, and/or may change the information requested from the user.

In another example, the credentials for a utility may not be needed. A third utility may be determined at operation 501, and submitted at operation 503. The account may be determined at operation 504, and the account may be submitted at operation 505. The credentials of the account may be determined not to be needed at operation 512. Operation 518 may determine whether the user has bill pay, and it may be determined that bill pay not needed at operation 519. The solar contracts may be determined at operation 521, and may be submitted at operation 523. Each of these operations may change the state of the state machine 400, and/or may change the information requested from the user. may be determined at operation 501, and submitted at operation 503 of FIG. 10. The account may be determined at operation 504, and the account may be submitted at operation 505. The credentials of the account may be submitted at operation 507, the credentials may be verified at operation 508, and the credentials may be determined to be correct at operation 510. Operation 518 may determine whether the user has bill pay, and the bill pay may be submitted at operation 520. The solar contracts may be determined at operation 521, and may be submitted at operation 523. Each of these operations in this example may change the state of the state machine 400, and/or may change the information requested from the user.

In yet another example, the credentials for the utility account of the user may not be available, and the copy of the bill from the user's utility may be used. A fourth utility may be determined at operation 501, and submitted at operation 503. The account may be determined at operation 504, and the account may be submitted at operation 505. The credentials of the account may be determined not to be available at operation 511. Operation 514 may determine whether the user is enrolling in bill pay service, and the bill pay services request may be submitted at operation 515. The solar contracts may be determined at operation 521 and may be submitted at operation 523. Each of these operations may change the state of the state machine 400, and/or may change the information requested from the user.

FIG. 14 shows a network arrangement of energy generating systems, servers, databases, and customer devices according to an implementation of the disclosed subject matter. A utility 30 (i.e., an electric utility) may generate electricity to be provided to one or more customers via a power grid. The utility 30 may include a server that provides an electric utility customer portal 32, which may allow customers to access account information with the utility 30. Account information may include, for example, utility bills, payment information, amount of energy used, address and contact information, and the like. The server of the utility 30 may be one or more hardware servers and or a cloud server. The server of the utility 30 that provides the electric utility customer portal 32 may be communicatively coupled to an electric utility database 34, which may store, among other things, historic utility bill statements for one or more customers. The utility 30 may be communicatively coupled to the server 13 via communications network 7.

The server 13 may be one or more hardware servers, cloud servers or the like, and may be connected to a solar inverter 40, and a solar energy generating system 42 (i.e., the community solar energy generating system). The solar inverter 40 may convert direct current (DC) output of a photovoltaic (PV) solar panels of the solar energy generating system 42 into an alternating current (AC) that may be provided into a commercial electrical grid, which may be the same power grid that the utility 30 is connected to. The solar inverter 40 may include a server (e.g., one or more hardware servers, a cloud server, or the like) to provide data logging and/or an application program interface (API). The data logger may determine the amount of energy generated by the solar energy generating system 42 over a predetermined period of time (e.g., one or more hours of the day, the amount of energy generated for one or more months, the amount of energy generated over a year, or the like). The API may provide at least a portion of the logged data to the server 13 and/or the customer device 20, and may be used to update (e.g., add, remove, or the like) customers that may be subscribed to the community solar energy generating system.

Customer allocation portal 50 may be provided by a server (e.g., one or more hardware servers, a cloud server, or the like), which may be communicatively coupled to customer allocation database 52. The allocation portal 50 may be accessed, for example, by the server 13 to set and/or adjust an allocation of the energy for a customer that is subscribed to the community solar energy generating system. The set and/or adjusted allocation for a customer may be stored in the customer allocation database 52.

In some implementations, the server for the customer allocation portal 50 may include the state machine 400, which may include hardware and/or software which may perform the operations shown in connection with FIGS. 1-12 and described above. In some implementations, the state machine 400 may be part of a server that is separate from, but communicatively connected to, the customer allocation portal 50.

The utility 30, the server 13, the customer allocation portal 50, and a customer device 20 (described below in connection with FIG. 16) may be communicatively connected via communications network 7. The network 7 may be a local network, wide-area network, the Internet, or any other suitable communication network or networks, and may be implemented on any suitable platform including wired and/or wireless networks.

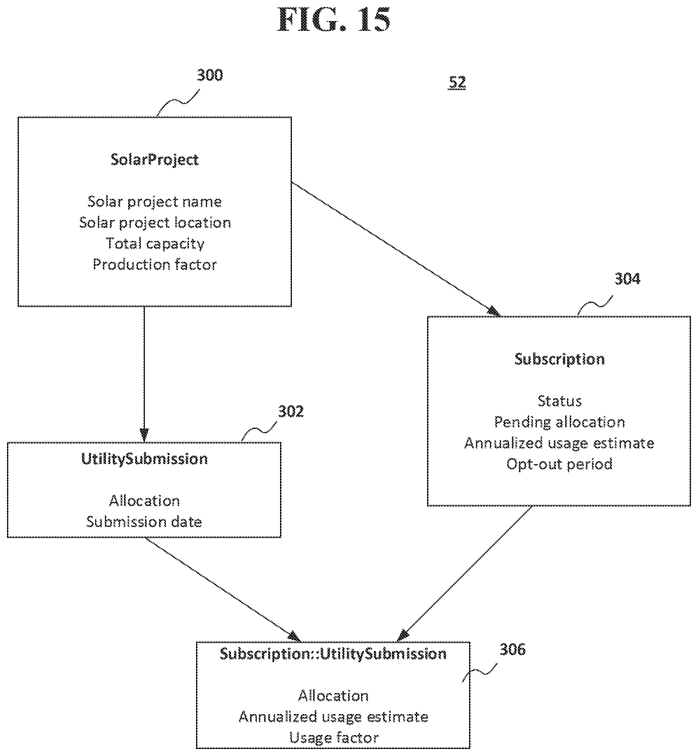

FIG. 15 shows a management data model that is stored in a database (e.g., customer allocation database 52 shown in FIG. 14) to track submission of customer allocations to a utility (e.g., utility 30 shown in FIG. 14) and/or rolling allocations by the customer allocation portal 50. That is, once one or more users have enrolled with community solar energy generating system, the management data model of FIG. 15 may be used to manage the energy allocations to each enrolled user of the community solar energy generating system.

The data structure 300 (i.e., SolarProject) may be for a solar energy project (i.e., a community solar energy generating system to be built or presently in operation, such as the solar energy generating system 42 shown in FIG. 14), that may include the name of the project, the location of the project, the total energy-generating capacity of the project, and a production factor. The production factor may be a measure of how much energy is generated per unit of system capacity, and may be expressed in kWh/kW (e.g., where kWh is the energy output, and kW is the capacity). The data structure 302 (i.e., UtilitySubmission) may include an energy allocation for the solar energy project (e.g., a community solar energy generating system), and a submission date of the allocation to a utility (e.g., utility 30 shown in FIG. 14). The data structure 304 (i.e., Subscription) may include a status of a customer (e.g., active, awaiting allocation, discontinued service, or the like), a pending energy allocation amount of the customer, an annualized usage estimate (e.g., an estimate historic energy usage rate), and a length of an opt-out period (e.g., the length of time that the customer has to respond to a notification to accept or decline to receive energy generated by the community solar energy generating system). The data structure 306 (i.e., Subscription::UtilitySubmission) may include the determined allocation of energy for the customer, the annualized usage estimate of energy usage for the customer, and a usage factor (as described above).

In some implementations, the customer allocation portal 50 shown in FIG. 14 may transmit a list of the one or more of the plurality of customers and the respective allocations of energy to a utility (e.g., utility 30 shown in FIG. 14). The utility may assign an allocation of energy and/or bill credits for each of the one or more of the plurality of customers based on the transmitted allocations from the customer allocation portal 50. The allocations for each customer may be stored in customer allocation database 52 shown in FIG. 14.

The customer allocation portal 50 may dynamically track energy allocation to one or more of the plurality of customers. The customer allocation portal 50 may transmit, via the communications network (e.g., communications network 7 shown in FIG. 14), the dynamically tracked energy usage for each of the one of more of the plurality of customers for display.

Embodiments of the presently disclosed subject matter may be implemented in and used with a variety of component and network architectures. FIG. 16 is an example customer device 20 that may a desktop or laptop computer, or a mobile computing device such as a smart phone, tablet, or the like. In some implementations, the device 20 may be used to provide user information to the state machine 400, manage a subscription to the community solar energy generating system, to manage an account with the utility 30, and/or receive billing information from the customer allocation portal 50. The device 20 may include a bus 21 which interconnects major components of the device 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as an internal hard drive, flash storage, and the like, a removable media component 25 operative to control and receive external storage such as an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the device 20 are generally stored on and accessed via a computer readable medium, such as a hard disk drive (e.g., fixed storage 23), an optical drive, floppy disk, or other storage medium.

The fixed storage 23 may be integral with the device 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including Ethernet, digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., sensors, energy use monitors, and the like). Conversely, all of the components shown in FIG. 6 need not be present to practice the present disclosure. The components can be interconnected in different ways from that shown. The operation of the device 20 such as that shown in FIG. 6 is readily known in the art and is not discussed in detail in this application. Code to implement the present disclosure can be stored in computer-readable storage media such as one or more of the memory 27, fixed storage 23, removable media 25, or on a remote storage location.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing implementations of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving, at a server that includes a state machine, at least a first zip code and a first energy utility name of a first user to enroll in a community solar energy generating system;
determining, at the server, a first geographic location based on the received first zip code and determining one or more first regulatory requirements based on the determined first geographic location;
generating, at the server, a first compilation of data that includes the received first zip code, the received first energy utility, the determined first geographic location, and the determined one or more first regulatory requirements;
providing, at the server, the first compilation of data via an application program interface (API) to the state machine;
changing the state machine to a first state based on the first compilation of data received via the API;
generating, at the server, a first interface to be displayed to the first user based on the first state of the state machine, wherein the first interface is configured to receive one or more first inputs from the first user; and
receiving, at the server, responses to the one or more first inputs received by the first interface.

2. The method of claim 1, further comprising:
receiving, at the server that includes the state machine, at least a second zip code and a second energy utility name of a second user to enroll in the community solar energy generating system;
determining, at the server, a second geographic location based on the received second zip code and determining one or more second regulatory requirements based on the second geographic location;
generating, at the server, a second compilation of data that includes the received second zip code, the received second energy utility, the determined second geographic location, and the determined one or more second regulatory requirements;
providing, at the server, the second compilation of data via the application program interface (API) to the state machine; and
changing the state machine to a second state based on the second compilation of data received via the API; and
generating, at the server, a second interface to be displayed to the second user based on the second state of the state machine, wherein the second interface is configured to receive one or more second inputs from the second user.

3. The method of claim 2, wherein at least one of the second zip code, the second energy utility name, the second energy utility, the second geographic location, and the one or more second regulatory requirements are different from at least one of the first zip code, the first energy utility name, the first energy utility, the first geographic location, and the one or more first regulatory requirements.

4. The method of claim 2, wherein the second state of the state machine is different from the first state of the state machine.

5. The method of claim 2, wherein the generated second interface is different at least in part from the first generate interface.

6. The method of claim 2, further comprising:
receiving, at the server, responses to the one or more second inputs received by the second interface.

7. The method of claim 1, further comprising:
adding, at the server, a new criteria for enrollment in the community solar energy generating system;
generating, at the server, an updated first compilation based on the new criteria;
providing, at the server, the updated first compilation of data via the API to the state machine;
changing the state machine to a third state based on the updated first compilation of data received via the API; and
generating, at the server, a third interface to be displayed to the first user based on the third state of the state machine, wherein the third interface is configured to receive one or more third inputs from the first user.

8. The method of claim 7, wherein the new criteria includes at least one selected from the group consisting of: an incentive, account information, billing information, document requirements, and at least one information item for the first user.
